(19) United States
(12) Patent Application Publication
(10) Pub. No.: US 2014/0032434 A1
(43) Pub. Date: Jan. 30, 2014

(54) SYSTEM AND METHOD TO DETERMINE COMPATIBILITY AND FACILITATE MATCHING

(71) Applicant: Subramani Anil Kumar, Chennai (IN)

(72) Inventor: Subramani Anil Kumar, Chennai (IN)

(21) Appl. No.: 13/977,768

(22) PCT Filed: Jan. 10, 2012
(86) PCT No.: PCT/IN2012/000028

§ 371 Date: Jul. 1, 2013

(30) Foreign Application Priority Data
Jan. 10, 2011 (IN) 3361/CHE/2010

(51) Int. Cl. G06Q 50/00; H04L 29/08

(52) U.S. Cl. CPC G06Q 50/01; H04L 67/306
USPC 705/319

(57) ABSTRACT

The present invention relates to a system-implemented method of determining compatibility and facilitating matching between users of the method. More particularly, the present invention caters to users who include single individuals as well as their families and helps to ensure a match not only in physical attributes, socio-cultural and socio-economic backgrounds, and values and ideals, but also in interests, aspirations, lifestyles, personality traits, and relationship goals and, consequently, time frames for marriage. The present invention provides users with a selective, stage-based profile privacy control mechanism, allowing them to control which prospects may view which specific fields or sections of their profile and at what stage of their interactions with those prospects. Further, the present invention collects and processes not only users' partner preferences but also information on the relative importance of the various indicated preferences both across possible matching criteria and within each criterion.

### FIELD OF INVENTION

The present invention relates to the field of online information exchange between users. Particularly, the present invention relates to a system-implemented method of determining compatibility and facilitating matching between users of the method. More particularly, the present invention caters to users who include single individuals as well as their families and helps to ensure a match not only in physical attributes, socio-cultural and socio-economic backgrounds, and values and ideals, but also in interests, aspirations, lifestyles, personality traits, and relationship goals and, consequently, time frames for marriage. The present invention facilitates multiple means of communication between users, including a structured process of secure, meaningful interactions over multiple stages, and also provides users with a selective, stage-based profile privacy control mechanism, allowing them to control which prospects may view which specific fields or sections of their profile and at what stage of their interactions with those prospects. Further, the present invention collects and processes not only users' partner preferences but also information on the relative importance of the various indicated preferences—both across possible matching criteria and within each criterion. Additionally, the present invention permits a user to indicate what charges a prospect may have to incur to communicate with the user, with the amount being a function of how well the prospect matches the user's partner preferences. The present invention also relates to an online method of determining compatibility by verifying people's identities and backgrounds using their networks of personal and professional relationships.

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyrights whatsoever.

### BACKGROUND ART

Human beings are evolutionarily wired for procreation and sociologically wired for companionship, and matchmakers have been in existence for probably as long as people have sought to enter into relationships. The art of matchmaking naturally evolves and keeps up with the times, but essentially it involves helping potentially compatible people come together.

In the present day, there are numerous ways in which people find a partner. These include: Self-initiated offline interactions with relatives, peers (such as classmates, colleagues, and friends), acquaintances and strangers; introductions through family, friends and acquaintances; the placing of classified ads in print media; and the use of online dating, social-networking/affinity-networking and matrimonial sites.

Of these, the Internet has made it especially easy for people to expand their personal networks and connect with people they would not have met otherwise. Not surprisingly, there exist numerous online dating, networking, and matrimonial sites. Many people have indeed found successful matches online. However, the existing matrimonial sites arguably serve as little more than databases of users' personal profiles, while networking sites—as commonly structured—are not quite suited for determining compatibility for a serious relationship. As a result, there is considerable dissatisfaction with the existing options. Moreover, there are also problems associated with misrepresentation on dating and matrimonial sites and authenticating a prospect's bona fides remains a constant challenge.

What makes the process of finding a compatible match more complicated today, whether online or off line, is the vast societal transformation that has taken place in recent decades. This is especially true of Indian society over the last generation. Young men and women in south Asia today have greater say in whom and when they marry. Yet, they must also contend with changing gender roles and expectations. They may continue to be comfortable with arranged marriages and go into one with the best of intentions. However, it takes more than that to make a marriage work. It does not help that families today are increasingly nuclear, due to which the support system for married couples is generally weaker. Unfortunately, more marriages are falling apart because of incompatible value systems and personalities.

The present invention relates to a matchmaking site that aims to go beyond the mere posting of bio datas or personals. It also proposes to give young men and women a better idea of who they are as individuals and what kind of person they would be truly compatible with. It also serves to help people develop the relationship skills necessary to make a marriage work and to help them nurture and celebrate their relationships for years to come. The present invention represents improvements over the prior art in numerous novel ways, as described below.

It recognizes that people at different stages in their lives and careers may have different time frames for finding someone to marry:
Some may be ready for marriage in the near term (say, within months of finding a match)
Some others may be ready for an engagement in the near term, but prefer a courtship period of about a year between getting engaged and tying the knot
Yet others may have an even longer time frame for marriage (a couple of years or more) and want to get to know someone over time

When all potential users are clubbed into the same category, even if that category is ostensibly matrimony, “search frictions” or inefficiencies, if not outright mismatches, inevitably result. These are widespread in the prior art. There are indeed numerous online dating sites that let people list their relationship goals as being, say, one or more of the following: activity partner; friendship; casual/short-term relationship; serious/long-term relationship; and marriage. After all, people may be flexible about their relationship goals and, as the case may be, time frames for marriage. However, the user of such a site may end up indicating a marriage time frame that is all over the map, so to speak. That is, the process of sorting and categorizing people according to their relationship goals and time frames is simplistic in the prior art.

It is known in the prior art, as illustrated in FIG. 1, that a user may indicate his/her partner preferences, which go towards collating profiles of potential matches. In this case, a user indicates that her age preference is “27 to 32,” height preference, “5-6 to 5-11,” and so on. In the case of qualitative fields such as marital status, complexion, and religion, one may enter or select from a number of choices, which is also illustrated in the screenshot. However, such a simple form and process collect only partner preferences, not information on how important those preferences are in one's search. Some matchmaking sites do allow a user to filter out prospects who do not meet certain criteria that are “non-negotiable,” as illustrated in FIG. 2. However, such filters are by nature binary, in that they are a switch that may only be turned on or off, depending on whether a criterion is important or not (e.g., US 20060015487). Such filters do not accommodate the possibility of associating varying degrees of importance to different values or ranges of values within the same criterion.

There exist matchmaking sites that allow a user to indicate how important a criterion is in their partner preferences. It is known in the prior art, as illustrated in FIG. 3 and FIG. 4, that some sites allow a user to indicate the relative importance of different criteria in their partner preferences. That is, as illustrated in FIG. 3 and FIG. 4, “smoking habits” may be “very important,” “drinking habits” may be “somewhat important,” “age” may be “somewhat important,” and “relationship history” may be “very important.” However, this establishes relative importance only in one dimension: across different criteria. Such systems seem to imply that there is no variation in partner preferences within a criterion, or alternatively, they may make assumptions or apply empirical models to address the variation of preferences within a criterion. For instance, in U.S. Pat. No. 6,272,467, the preferences of a user are varied based upon normative data associated with traits such as weight and height or the age of a potential match. Also it is known in the prior art that users normally pay a subscription fee for the use of a matchmaking service. The subscription fee is typically for unlimited use over a finite period of time, typically ranging from a month to a year. Some systems also charge users fees on a pay-per-use/pay-per-contact basis. There also exist related, job recruiting systems in which the revenue model is based on requiring recruiters to pay a set amount to contact a candidate whose resume appears in the database and/or on paying users a set amount to have their resumes added to the database. However, we are not aware of a matchmaking site or related system in which the charges that a user incurs to contact another user are a function of the degree of match between the users.

Moreover, in the prior art the matchmaking sites allow users to indicate simply that they will reveal a particular piece of information “later.” The information may simply not be entered or may be password-protected. Some other systems offer profile privacy settings based on the nature of one's relationship with potential viewers of one's profile. One instance of relevant prior art is as shown in FIG. 5 and another is described in U.S. Pat. No. 7,725,525. However, there does not seem to exist a system that offers profile privacy controls that are triggered, possibly automatically, by the extent or stage of interactions and, consequently, the changing level of familiarity between two users.

In South Asian cultures, marriages are often not just about two individuals coming together, but about two families coming together. As a result, the process of finding a match typically involves many stakeholders. The existing matchmaking sites—including U.S. Pat. No. 7,085,806 and US 20060287878, which allows third-party users or intermediaries to search for prospects on behalf of a “client user” and to introduce prospects to the client—do not sufficiently recognize this. They may allow a parent, guardian, friend, sibling, or other relative to create a profile and communicate with potential matches on one's behalf, but activity on a profile account, especially as it relates to reviewing potential matches, tends to be restricted to one registered user.

There also exists a need for a system-implemented method which helps to verify people's identities and backgrounds, such as by using the help of one's network of personal and professional relationships. In the prior art, there exist matchmaking sites (including the invention described in US 20060287878) that allow users to include testimonials and references, from trusted others, in their profiles. However, coming from strangers, these references may not be objective or credible. There also exist matchmaking sites that require or give users the option of having their credentials verified, whether by uploading copies of documents that vouch for one's identity, age, location, and professional qualifications or using tools offered by some external service provider who authenticates, say, the user's name, age, and location. However, supporting documents may still be forged, and tools or services that vouch for limited particulars about a prospect do not sufficiently assure a user of a prospect's background. There are matchmaking applications and related sites that leverage social networking sites to help users determine if they have friends and acquaintances in common with a prospect. However, such systems do not offer the kind and extent of privacy controls that a matchmaking site's user may want. While they may help to verify people's identities and backgrounds using one's network of friends and acquaintances, such systems come with the potential risk of creating much awkwardness (should a user not “click” with a prospect who may be a friend of a friend), since matchmaking services are slapped onto existing, well-entrenched social networks.

Various other features of the system and method of the present invention will become obvious to those skilled in the art upon reading the disclosure set forth hereinafter.

### OBJECT OF THE INVENTION

Thus the primary object of the present invention is directed to an online system-implemented method of determining compatibility and facilitating matching among users of the method.

It is another object of the present invention, wherein the system-implemented method of determining compatibility and facilitating matching caters to individuals who themselves seek to find a companion or partner and also to individuals who are being helped by others (whether a relative, friend, and/or acquaintance) in their search for a companion or partner.

It is another object of the present invention to provide a system-implemented method of determining compatibility and facilitating matching to users who come pre-screened.

It is yet another object of the present invention, wherein the system-implemented method caters to users who include single individuals as well as their families and helps to ensure a match not only in physical attributes, socio-cultural and socio-economic backgrounds, and values and ideals, but also in interests, aspirations, lifestyles and personality traits.

It is an object of the present invention, wherein the method categorizes and matches users in a way that also takes into account their respective lifestages and desired time frames for marriage.

It is another object of the present invention, wherein users' possible lifestages include but are not limited to lifestages with the following corresponding relationship goals: To explore compatibility as friends first; to be engaged in the near term (with a courtship period before marriage); to be married in the near term; and to nurture and celebrate relationships (whether one's existing family relationships or new ones).

It is another object of the present invention, wherein the method allows users to indicate that their time frame for marriage is flexible.

It is another object of the present invention, to provide a “primary” and any “secondary” relationship goal which are associated with lifestages that are generally close to each other in time, so that one's indicated relationship goals, and time frame for marriage, are not “all over the map”.

It is yet another object of the present invention, wherein users are matched not only with those users who have similar time frames for marriage but also with those with whom they have potentially overlapping time frames for marriage and, consequently, overlapping near-term relationship goals.

It is another object of the present invention, wherein the system-implemented method collects information about users' partner preferences in a particular manner to match them with someone compatible.

It is another object of the present invention, wherein the system allows a user to specify which select profile particulars he or she would like to see as part of a prospect's profile summary, rather than have to scroll through and scour a prospect's entire profile information.

It is another object of the present invention, wherein the system enables the collection and display of information relating to the variation of a user's profile characteristics (such as values, ideals, lifestyle choices, hobbies, interests, aspirations, and traits) over time.

It is another object of the present invention, wherein the system enables a user's partner preferences to be updated automatically following an updating of information about the user himself/herself, such that the change in partner preferences are, say, consistent with or appropriate to the change in the user's own attributes.

It is another object of the present invention, wherein the system enables a user to indicate their partner preferences not only in absolute terms (as in indicating a preference for specific attributes) but also in relative terms—as in relative to the user's own attributes or to benchmarks derived from a population sample, such as a sample of users on the site or in a particular demographic or psychographic segment.

It is another object of the present invention, wherein information on a user's partner preferences, across a number of possible matching criteria, is collected and processed along with information on the relative importance of the various indicated preferences.

It is yet another object of the present invention, wherein a user's partner preferences, across a number of possible matching criteria, are collected in a manner that captures how important each potential criterion is relative to another and also, within each potential criterion, how preferable some possible criterion values or ranges of values are relative to other possible values or ranges of values.

It is another object of the present invention, wherein weights are assigned to both a potential criterion's degree of importance and the values or ranges of values within a criterion, to facilitate a sorting and ranking of potential matches.

It is another object of the present invention, wherein a user's multi-dimensional preference index may derive either wholly from user-specified weights or partly from user-specified weights; empirical data; hypotheses on the relative importance of potential criteria and the variation of people's partner preferences within each possible criterion; input from people known to the user; user behavior, including a user's browsing history on the site; and/or user interactions history, including feedback and information on why users approved, disapproved, accepted, rejected, were interested in or uninterested in previous prospects.

It is another object of the present invention, wherein the method incorporates Boolean logic to allow people to make trade-offs in their partner preferences.

It is another object of the present invention, wherein a user's partner preferences are collected and processed in a way that enables the determination of the degree of match between the user and some other user of the method (and vice versa).

It is another object of the present invention, wherein how much a user is charged to communicate with a prospect is a function of the degree of match between the two users. In one implementation of the invention, the amount charged is a function of how well the user matches the prospect's partner preferences.

It is another object of the present invention, wherein the amount that a user is charged to contact a prospect may be charged in any appropriate unit of real or virtual currency, with the users engaging in separate transactions to acquire the virtual currency.

It is another object of the present invention, wherein a user may specify additional monies (in any appropriate unit of real or virtual currency) that a prospect would have to pay, to contact the user, if the prospect's profile characteristics place him or her outside the user's ideal range of preferences.

It is another object of the present invention, wherein a user may specify an additional premium (in any appropriate unit of real or virtual currency) that a prospect would have to pay, to contact the user, with this premium merely reflecting the user's selectivity in fielding enquiries from prospects.

It is another object of the present invention, wherein users receive credit, virtual currency, or points for activity and specific actions undertaken on the site, with the credit, virtual currency, or points being redeemable towards other activity or specific actions on the site.

It is another object of the present invention, wherein if a user were not to use or redeem, within a set period of time, any credit, virtual currency, or points that they have earned or accumulated, then such credit, virtual currency, or points would expire.

It is another object of the present invention, wherein the system does not display or reveal a user's profile particulars, including any personally-identifiable information to the public at large; instead, a user's profile information is shared only with select prospects on the basis of the degree of match between the user and potential matches.

It is another object of the present invention, wherein a user may reveal their profile information to a prospect selectively, in stages, as the user gets to know the prospect better. In one implementation of the method, these stages consist of an intuitive set of multiple, secure interaction stages through which two users are guided as they are matched and subsequently (should they want to) get to know each other.

It is another object of the present invention, wherein a user has the ability to choose specifically when (that is, at what stage of interactions) they reveal certain profile particulars to prospects. It is another object of the present invention, wherein the system provides a specific, selective, stage-triggered profile privacy control mechanism, to open up specific fields or sections of the user's profile to prospects.

It is another object of the present invention, wherein the profile privacy control mechanism may be automated, adjusted, or re-adjusted by a user through the activation of appropriate profile information display settings, to open up specific fields or sections of the user's profile to a prospect, depending on the stage or level of interactions reached by the user in his or her interactions with the prospect.

It is yet another object of the present invention, wherein the profile privacy control mechanism allows for a user to request, of a prospect, the revealing of specific fields or sections of the prospect's profile and for the prospect to deliberately reveal (should they choose to) specific fields or sections of their profile to the user.

It is another object of the present invention, wherein a user's “responsiveness” rating is calculated as a function of how responsive the user is to requests (including invitations to communicate) and gestures (including compliments) from prospects.

It is another object of the present invention, wherein if a user's responsiveness rating falls below a pre-determined threshold, the user's ability to initiate interactions with prospects may be placed on hold until the user attends to messages previously received from prospects.

It is another object of the present invention, wherein users are provided with the means to collate various prospects' contact information and pertinent particulars into a single repository or database, for easy access and reference.

It is another object of the present invention, wherein a user may involve other individuals—such as a relative, friend, or acquaintance—in his or her search for a partner. The user and his/her “people” (MyPeople) would have the option of later changing the stage, nature, and extent of such MyPeople involvement in the search process for a partner.

It is another object of the present invention, wherein the system includes multiple individuals and “group” logins associated with a user profile (on the matchmaking site), with appropriate read/review/rate/communicate privileges set by the matchmaking site user's designated profile manager.

It is another object of the present invention, wherein a user may set up a “prospect ratings” sheet corresponding to his or her partner preferences and provide his or her MyPeople group members with the option of submitting their opinions on or ratings of the prospects.

It is another object of the present invention, wherein a user's MyPeople group members may have privileges that include forwarding a profile to another user or potential user; adding searched profiles to a user's shortlist, for his/her consideration; rating shortlisted profiles or prospects; and even initiating communications or interactions with a prospect at the site, on behalf of the user.

It is another object of the present invention, wherein a user's group members may insert testimonials or provide references to the user.

It is another object of the present invention to provide an online method of determining compatibility by verifying people's identities and backgrounds using users' networks of personal and professional relationships.

It is another object of the present invention, wherein the system-implemented method includes a matchmaking web site or system, in which the users enter information about themselves and their partner preferences, and a separate but integrated networking web site or system, at which the users create and expand their social graphs by connecting online with the people in their lives.

It is another object of the present invention, wherein the integration between the matchmaking site and the networking site enables users of the matchmaking site (including individual users and their families) to do due diligence on prospective matches with the help of the networking site. In one implementation of the system, the due diligence may take the form of assessing someone's personal and professional background and network of relationships.

It is yet another object of the present invention, wherein two users of the matchmaking site may discover, using the integrated networking site, connections such as peers, friends, or acquaintances they may have in common.

It is another object of the present invention, wherein there exists interplay between the matchmaking site and the networking site, allowing the matchmaking site's users to be retained and served by the networking site long after the completion of the matchmaking process.

It is another object of the present invention, wherein the method facilitates meetings between two users (with or without either's family members being involved)

It is another object of the present invention, wherein the method also facilitates online interactions between users in a manner that mimics users' entering a room and knowing, readily, with whom they have things in common.

It is another object of the present invention, wherein when a user and a prospect decide to pursue a relationship and may be considered to be a “success story,” the system extracts and presents to the new couple their profile particulars, interaction history, and activity stream, in a manner that allows them to select excerpts for collation into an album, digest, or multi-media exhibit that is reproducible in print and/or electronic media and serves as a souvenir to remind the couple and their descendants of how they came together.

### SUMMARY OF THE INVENTION

Thus according to the basic aspect of the present invention there is provided a system-implemented method of determining compatibility and facilitating matching between users of the method, comprising the following:
a matchmaking web site;
registration of users;
creation of a user profile by registered users;
enabling users to provide their partner preferences;
collating and processing of information, within one or more databases, relating to user profiles and users' partner preferences;
assigning of weights to users' partner preferences;
matching of users with other, potentially compatible users or prospects;
determining degree of match between the matched users;
notifying users of other users with whom they may be compatible;
displaying users' profiles to their potential matches;
facilitating multiple means and multiple stages of communication and interaction between users;
assigning users a responsiveness rating that is calculated based on how responsive they are to other users on the site;
a user profile privacy control mechanism that enables users to control which prospects get to view their profile particulars and at what stage in a user's interactions with a prospect;
charging users a fee in real or virtual currency to permit them to communicate or interact with other users;
allowing users to earn redeemable credits, virtual currencies, or points for activities or specific actions undertaken on the site;
enabling a user to involve other individuals in the search for a partner, with appropriate user privileges set by the user's designated profile manager;
enabling multiple individuals and “group” logins to be associated with a user profile;
archiving the progression of users' interactions with and potential relationship stories involving other users; and
a social networking web site.

It is another aspect of the present invention, wherein the user registration may be restricted and is either by invitation only or enabled only for credentialed users.

It is another aspect of the present invention, wherein the verification of a user's credentials may be achieved by means of a gateway providing access to verified members.

It is another aspect of the present invention, wherein the categorization and matching of users is based on criteria that include the users' respective lifestages and indicated time frames for marriage, wherein the time frames may be similar or overlapping.

It is another aspect of the present invention, wherein the life stages and time frames for marriage may be user-customizable.

It is another aspect of the present invention, wherein the registered users may customize the profile particulars they wish to see displayed as part of a prospect's profile summary.

It is another aspect of the present invention, wherein the system enables the collection and display of information relating to the variation of a user's profile characteristics over time.

It is another aspect of the present invention, wherein the system enables a user's partner preferences to be updated automatically following an updating of information about the user.

It is another aspect of the present invention, wherein the system enables a user to indicate their partner preferences in absolute terms and/or in relative terms.

It is another aspect of the present invention, wherein the method incorporates Boolean logic to allow people to make trade-offs in their partner preferences.

It is another aspect of the present invention, wherein the user's partner preferences, are collected and processed in a manner that captures how important a potential criterion is relative to another and also, within a potential criterion, how preferable some possible preferences, values, or ranges of values are relative to other possible preferences, values, or ranges of values.

It is another aspect of the present invention, wherein the weights may be assigned default values by the system and/or may be user customizable.

It is another aspect of the present invention, wherein the weights may derive either wholly from user-specified weights or partly from user-specified weights; empirical data; hypotheses on the relative importance of potential criteria and the variation of people's partner preferences within each possible criterion; input from people known to the user; user behavior, including a user's browsing history on the site; and/or user interactions history, including feedback and information on why users approved, disapproved, accepted, rejected, were interested in or uninterested in previous prospects.

It is another aspect of the present invention, wherein the profile privacy control mechanism may be automated, adjusted, or re-adjusted by a user.

It is another aspect of the present invention, wherein the profile privacy control mechanism allows for a user to request, of a prospect, the revealing of profile particulars.

It is another aspect of the present invention, wherein how much a user is charged to communicate or interact with other users is a function of the degree of match between the two users.

It is another aspect of the present invention, wherein a user may specify additional monies, in any appropriate unit of real or virtual currency that a prospect would have to pay to communicate or interact with the user.

It is another aspect of the present invention, wherein the profile display particulars includes the charges payable in real or virtual currency to communicate or interact with the prospect.

It is another aspect of the present invention, wherein if a user's responsiveness rating falls below a threshold, then the user's ability to communicate or interact with prospects may be placed on hold.

It is another aspect of the present invention, wherein the user and any of the individuals involved in the user's search may have the option of changing the stage, nature, and extent of such involvement.

It is another aspect of the present invention, wherein a matchmaking site user's group members may have privileges that include offering testimonials for inclusion in a user's profile; serving as references to a user; forwarding a profile to another user or potential user; adding searched profiles to a user's shortlist, for his/her consideration; reading, reviewing and rating user profiles; and interacting with a prospect at the site.

It is another aspect of the present invention, wherein a user group's reviews, ratings, and messages pertaining to a prospect's profile may remain private to the group concerned and specific to that prospect's profile.

It is another aspect of the present invention, wherein the method facilitates meetings between two users, with or without either user's group members being involved, and includes exchanging of relevant information.

It is another aspect of the present invention, wherein the method also facilitates the coming together of potentially compatible users for online interactions that include instant messaging and near-real-time communications or interactions.

It is another aspect of the present invention, wherein users are provided with the means to collate prospects' contact information and pertinent particulars into a repository or database.

It is another aspect of the present invention, wherein the system may extract and present to a pair of users their profile particulars, interaction history, activity stream, and/or any other relevant or interesting information.

It is another aspect of the present invention, wherein in the matchmaking web site the users enter profile information and indicate partner preferences, and in the networking web site the users create and expand their social graphs by connecting online with other people.

It is another aspect of the present invention, wherein a user may populate his or her network either directly at the networking site or from within the matchmaking site.

It is another aspect of the present invention, wherein a user may port select information from his or her networking site profile to his or her profile at the matchmaking site.

It is another aspect of the present invention, wherein a group member's profile at a user's matchmaking site profile may be linked to the group member's networking site profile.

It is another aspect of the present invention, wherein users of the matchmaking site may discover, using the networking site, connections they may have in common; verify prospects' identities and backgrounds; and/or better gauge compatibility using additional potential information gathered from the networking site.

### BRIEF DESCRIPTION OF THE DRAWINGS

FIG. 1 shows a screenshot, from prior art, illustrating the entry/selection of one's partner preferences.

FIG. 2 shows another screenshot, from prior art, illustrating the activation of partner preference filters.

FIG. 3 shows another screenshot, from prior art, illustrating the entry/selection of partner preferences.

FIG. 4 shows yet another screenshot, from prior art, illustrating the entry/selection of partner preferences.

FIG. 5 shows yet another screenshot, from prior art, illustrating some profile privacy setting options.

FIG. 6 illustrates a lifestage map in an implementation of the present invention. Table 1 lists the potential sets of compatible lifestage maps in an implementation of the present invention.

FIG. 7 shows a screenshot from the present invention, illustrating a prospect's profile summary, including a portion (“Plus more”) that the user has customized so as to readily display fields that matter to the user.

FIG. 8 illustrates how information is gathered, in the present invention, on the relative importance of different partner preference criteria.

FIG. 9 illustrates how information is gathered, in the present invention, on the varying degrees of importance of values (or ranges of values) within a partner preference criterion.

FIG. 10 shows a screenshot from the present invention, illustrating the simple implementation of partner preference weights.

FIG. 11 shows a screenshot from the present invention, illustrating the advanced implementation of partner preference weights.

FIG. 12 shows a screenshot from the present invention, illustrating how well a user matches a prospect's partner preferences.

FIG. 13 shows an advanced preference graph, in an implementation of the present invention, illustrating the degree of match, the user's selectivity, and the message meter.

FIG. 14 shows a screenshot illustrating stage-wise interactions between two users according to the present invention.

FIG. 15 illustrates how a user associates stage-specific privacy settings to profile particulars according to the present invention.

FIG. 16 shows a screenshot illustrating a user's setting up of a PeopleTree according to the present invention.

FIG. 17 shows a screenshot from the present invention, illustrating a user's designation of people who would assist him/her in the search for a partner.

FIG. 18 shows another screenshot from the present invention, illustrating a user's designation of people who would assist him/her in the search for a partner.

FIG. 19 shows a screenshot from the present invention, illustrating how a user's MyPeople team members exchange messages with each other about a potential match.

FIG. 20 shows a screenshot from the present invention, illustrating the initiation of a meeting between potential matches.

FIG. 21 shows another screenshot from the present invention, illustrating meeting-related user interactions.

FIG. 22 shows another screenshot from the present invention, illustrating the collecting of post-meeting user feedback.

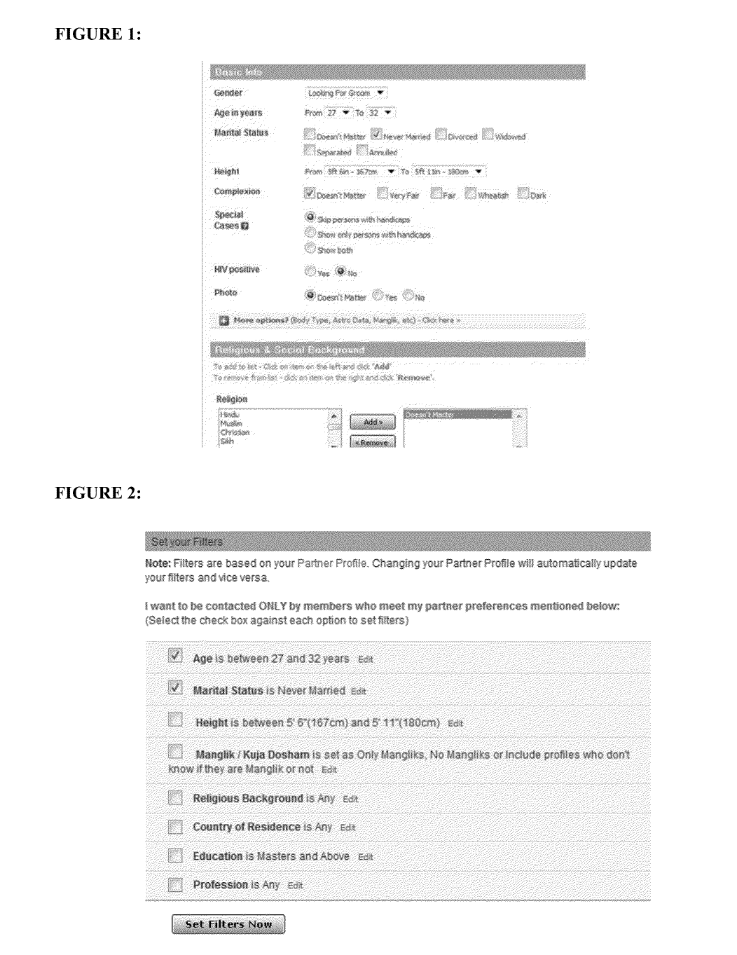

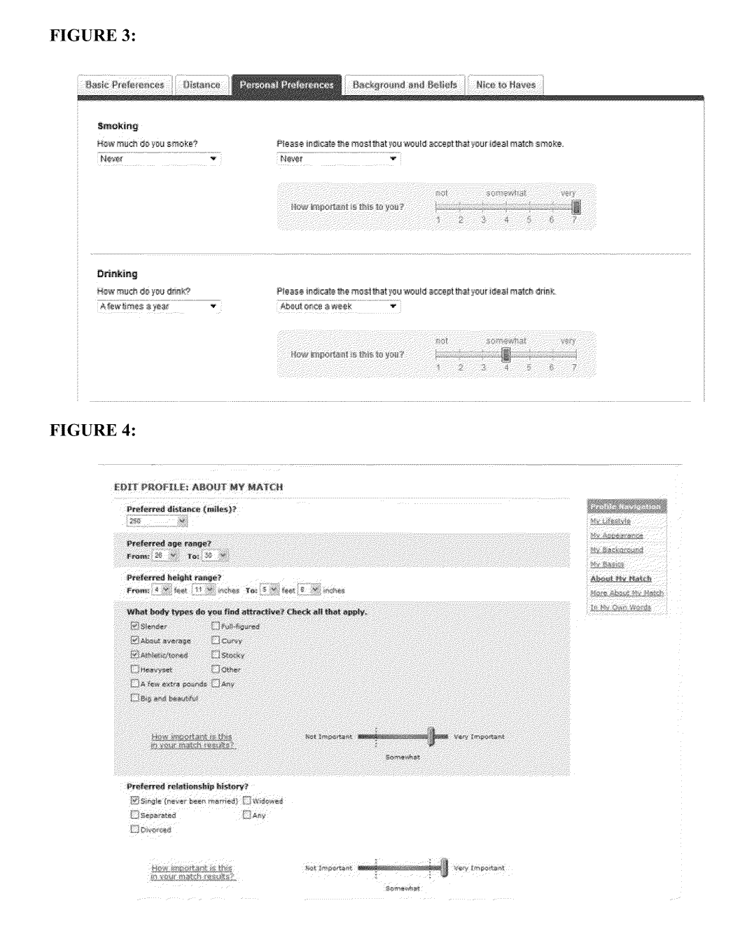

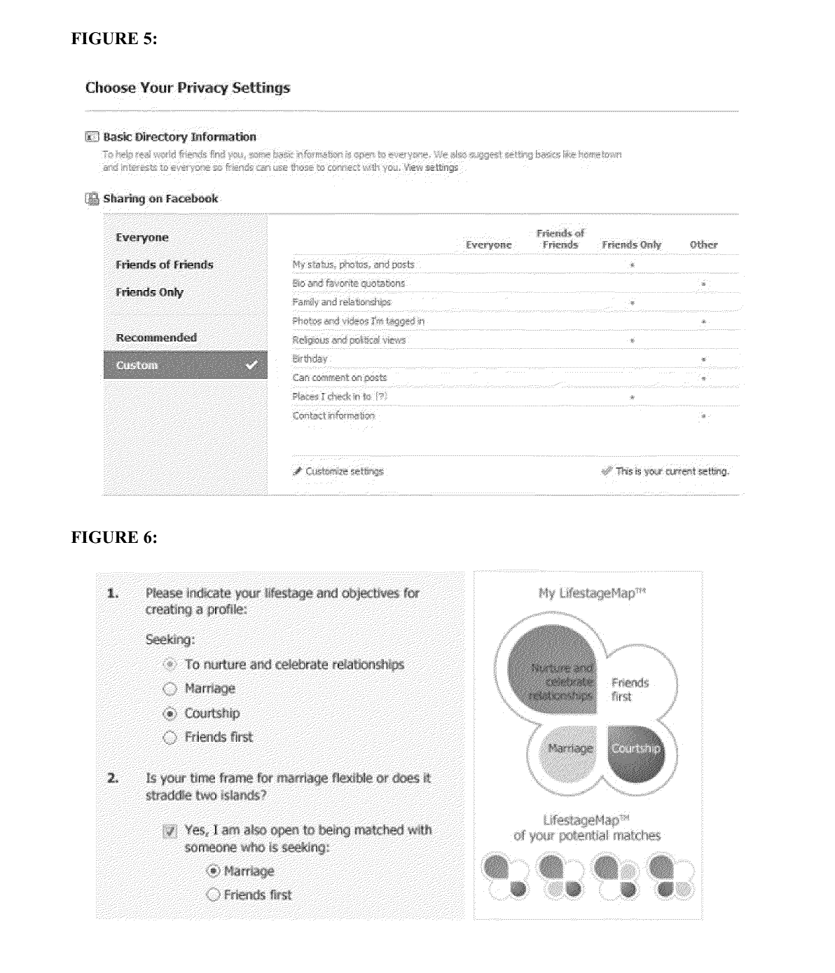

### DETAILED DESCRIPTION OF THE INVENTION WITH REFERENCE TO THE ACCOMPANYING DRAWINGS

The present invention as discussed hereinbefore relates to a system and method of determining compatibility and facilitating matching between users of the method. The system is devised in such a way that it inherently contains profiles of quality singles and user registration may be restricted on the basis of criteria that assure quality profiles. In one implementation of the method, user registration is either by invitation only or enabled through the means of a gateway that may be accessed only by credentialed users. In one implementation of the system, such gateways may be installed at the web sites of select communities (however defined), enabling access into the system only to members of those communities.

The method categorizes and matches users in a way that also takes into account their respective lifestages and desired time frames for marriage. The users' possible lifestages include but are not limited to lifestages with the following corresponding relationship goals: To explore compatibility as friends first; to be engaged in the near term (with a courtship period before marriage); to be married in the near term; and to nurture and celebrate relationships (whether one's existing family relationships or new ones). The method also allows users to indicate that their time frame for marriage is flexible, for instance by indicating the time frame in terms of: (1) The relationship goal that they are primarily seeking (in the near term) and (2) Whether they are also open to being matched with someone who is primarily seeking a different relationship goal—provided, however, that such “primary” and any “secondary” relationship goals are associated with lifestages that are generally close to each other in time, so that one's indicated relationship goals, and consequently, time frame for marriage, are not “all over the map,” so to speak. The users are matched not only with those users who have similar time frames for marriage but also with those with whom they have potentially overlapping time frames for marriage and, consequently, overlapping near-term relationship goals.

The foregoing object is explained hereunder in detail: Suppose that a user has indicated that he or she is primarily seeking, say, “Marriage” and is also open to being matched with a prospect who is primarily seeking, say, “A courtship.” Suppose that another user has indicated that he or she is primarily seeking, say, “A courtship” and is also open to being matched with a prospect who is primarily seeking, say, “Marriage.” Then, these two users are said to have overlapping time frames for marriage and they are tagged as being potential matches, with respect to compatibility in time frames for marriage. The second user may also be matched with someone whose primary and sole objective is to seek, say, “A courtship” or with another user whose primary objective is to seek “A courtship” and who is also open to, say, “exploring compatibility as friends first.”

Sample sets of potential matches, with respect to compatibility in time frames for marriage, for users whose near-term relationship goal includes either marriage, courtship, or “friends first,” or straddles any two of these three goals, are illustrated in FIG. 6 and listed in Table 1.

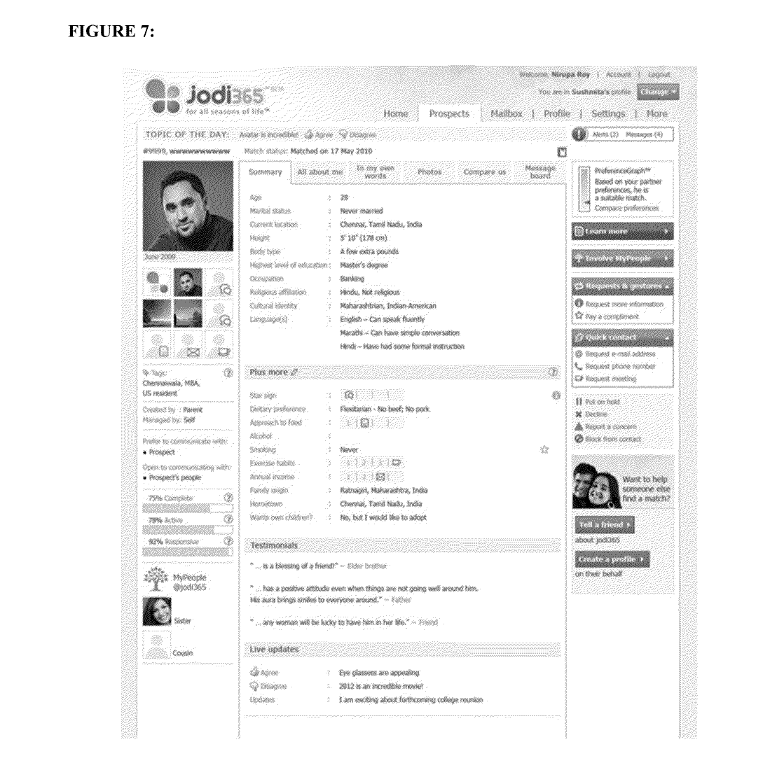

The system allows a user to specify which select profile particulars he or she would like to see as part of a prospect's profile summary, rather than have to scroll through and scour a prospect's entire profile information. Such a customizable summary view of a prospect's profile is illustrated in FIG. 7 (under “Plus More”). A user indicates their partner preferences not only in absolute terms (as in indicating a preference for specific attributes) but also in relative terms—as in relative to the user's own attributes or to benchmarks derived from a population sample, such as a sample of users on the site or in a particular demographic or psychographic segment. In one implementation of the method, the user may indicate that their age range preference is not, say, “27 to 32 years,” but “X−1 to X+4,” where X represents the user's own age.

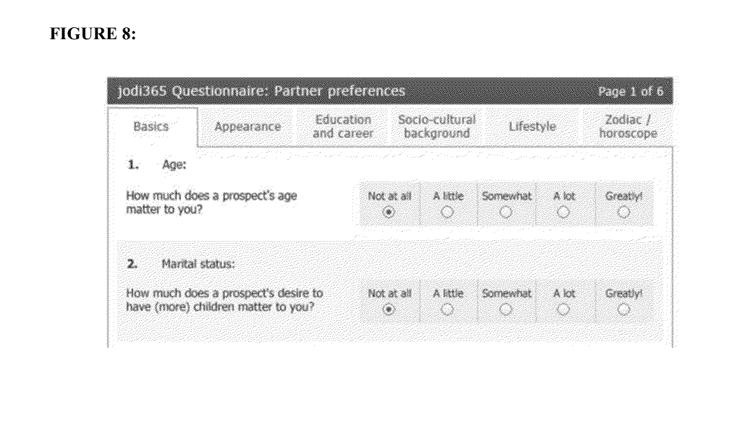

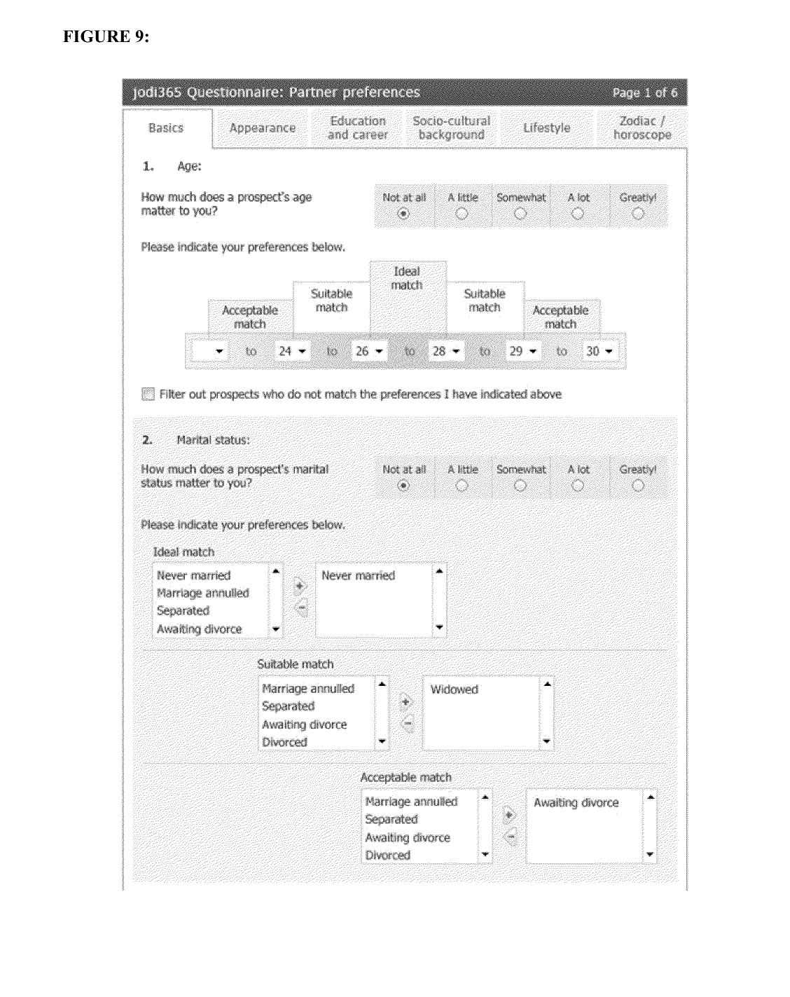

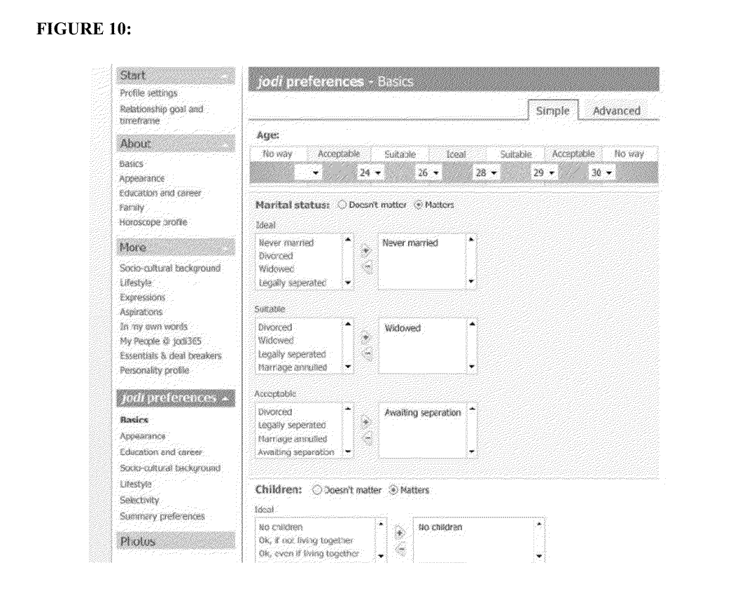

The information on a user's partner preferences, across a number of possible matching criteria, is collected and processed along with information on the relative importance of the various indicated preferences. The partner preferences are collected in a manner that captures how important each potential criterion is relative to another and also, within each potential criterion, how preferable some possible criterion values or ranges of values are relative to other possible values or ranges of values. That is, a two-dimensional preference index captures and comparatively ranks preferences both across possible matching criteria and within each possible criterion, as illustrated in FIG. 8 and FIG. 9, respectively.

Weights are assigned to both a potential criterion's degree of importance and the values or ranges of values within a criterion, to facilitate a sorting and ranking of potential matches. A user's multi-dimensional preference index may derive either wholly from user-specified weights or partly from user-specified weights; empirical data; hypotheses on the relative importance of potential criteria and the variation of people's partner preferences within each possible criterion; input from people known to the user; user behavior, including a user's browsing history on the site; and/or user interactions history, including feedback and information on why users approved, disapproved, accepted, rejected, were interested in or uninterested in previous prospects.

The user is blind to the default, system-implemented weights associated with the relative degrees of importance of possible matching criteria (e.g., the weights associated with degrees such as “not at all,” “a little,” “somewhat,” “a lot,” and “greatly,” as illustrated in FIG. 8) and the partner preference levels within a criterion (e.g., the weights associated with partner preference levels such as “ideal match,” “suitable match,” and “acceptable match,” as illustrated in FIG. 9).

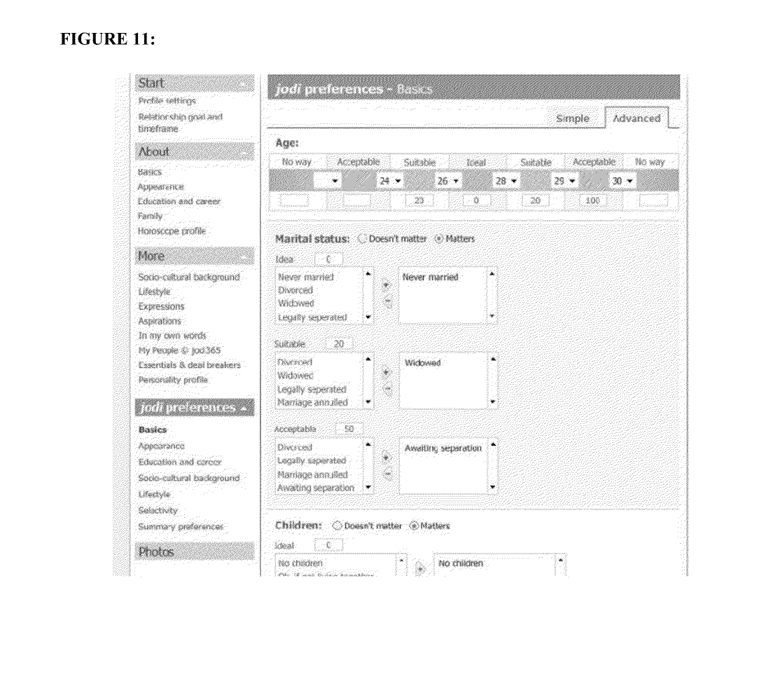

In an advanced implementation of the method, the user has the option of explicitly specifying and adjusting the weights associated with the relative importance of possible matching criteria and also the weights associated with possible values or ranges of values within a criterion. The difference between the simple and advanced implementations is illustrated in a comparison of FIG. 10 (simple implementation) and FIG. 11 (advanced implementation).

In another advanced implementation of the invention, the method incorporates Boolean logic to allow people to make trade-offs in their partner preferences. That is, a user may value one or more partner preference criteria so highly or find one or more characteristics so desirable in a prospect that the criterion or characteristic or combinations thereof may outweigh one or more other criteria or preferences that the prospect does not match or barely matches. For e.g., a user may find and accordingly indicate “Telugu-speaking AND dentist AND located in Bengaluru” to be so preferable that the combination would make up for one or more otherwise unacceptable or barely-acceptable traits such as, say, the prospect's age being 32 and therefore outside the user's “ideal match” age range of “27 to 30.”

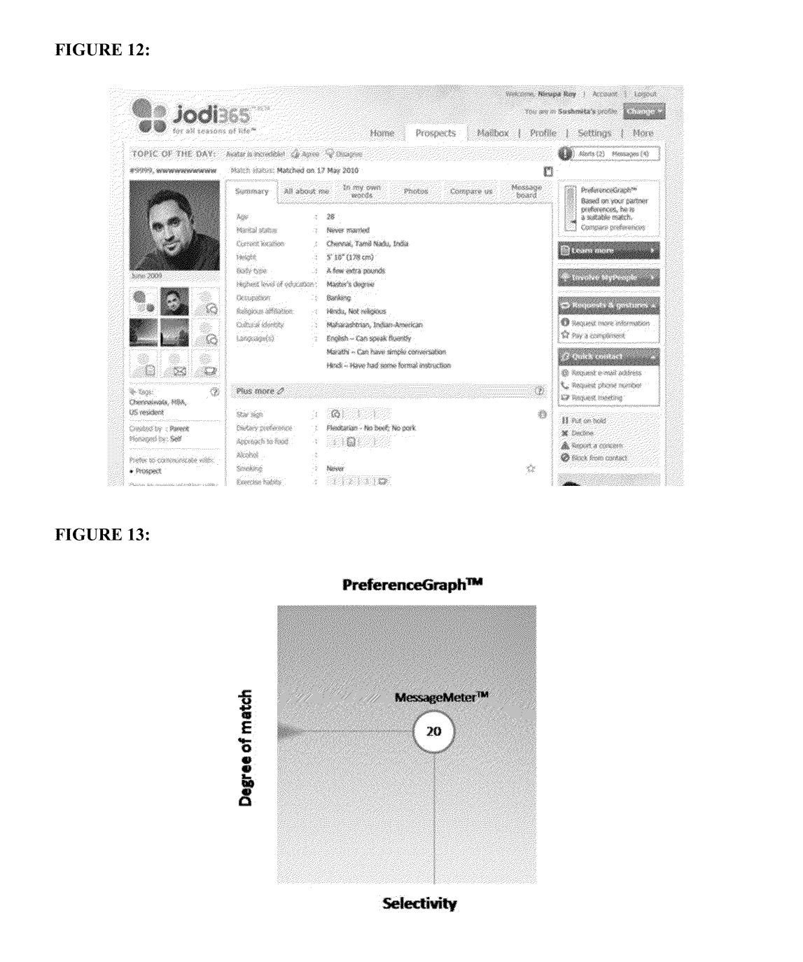

A user's partner preferences—including the multi-dimensional preference index that captures and comparatively ranks preferences both across possible criteria and within each possible criterion—are collected and processed in a way that enables the determination of the degree of match between the user and some other user of the method (and vice versa). In one implementation of the method, how well a prospect matches a user's partner preferences is displayed as part of the prospect's profile as illustrated in FIG. 12, under “PreferenceGraph” in the right column.

In one implementation of the invention, a user may be matched with one of three types of users: (1) another user who meets the first user's partner preferences (to some degree), but whose own partner preferences are not met by the first user; (2) another user whose partner preferences are met (to some degree) by the first user, but who does not meet the first user's partner preferences; and (3) another user who meets the first user's partner preferences and whose own partner preferences are met by the first user.

In one implementation of the invention, the amount that a user is charged to communicate with a prospect is a function of the degree of match between the two users. In another implementation of the invention, the amount charged is a function of how well the user matches the prospect's partner preferences. In such a case, the method calculates the total amount that the user may have to pay to contact the prospect. The total is then displayed in the form of a “message meter” (for messaging the prospect) within the prospect's profile, as illustrated in FIG. 13.

The amount that a user is charged to contact a prospect may be charged in any appropriate unit of real or virtual currency, with the users engaging in separate transactions to acquire the virtual currency. In one implementation of the invention, a user may specify additional monies (in any appropriate unit of real or virtual currency) that a prospect would have to pay, to contact the user, if their characteristics place them outside the user's range of preferences (whether “ideal,” “suitable,” or “acceptable, as illustrated in FIG. 11). Also, a user may specify an additional premium (in any appropriate unit of real or virtual currency) that a prospect would have to pay, to contact the user, with this premium merely reflecting the user's selectivity in fielding enquiries from prospects. This is also reflected, and illustrated, in FIG. 13.

In one implementation of the invention, users would receive credit, virtual currency, or points for activity and specific actions undertaken on the site, with the credit, virtual currency, or points being redeemable towards other activity or specific actions on the site.

In one implementation of the method, the users may receive points for, say, every day and every week that they access the site, for every profile that they view, for every poll that they take, or for every communication or interaction that they initiate or participate in. Users may also receive virtual gifts in lieu of the points; use the accumulated points to buy virtual gifts such as flowers, scrolls, icons, dolls, or greeting cards; and use the virtual gifts in their communications or interactions with other users or prospects, to give their communications additional significance through the allocation and use of such relatively scarce, earned resources.

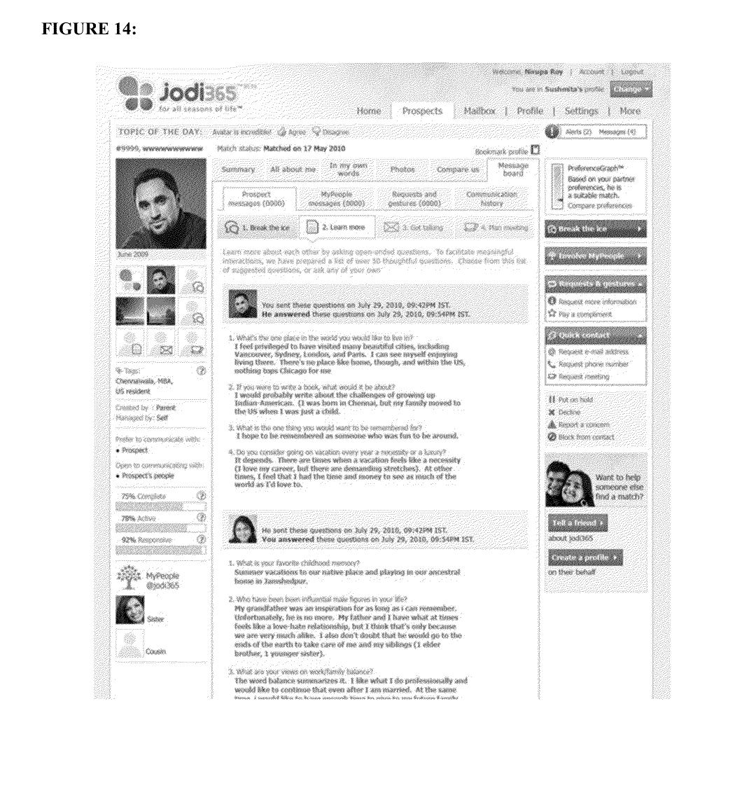

The system does not display or reveal a user's personally-identifiable information to the public at large; instead, a user's profile information is shared only with select prospects on the basis of the degree of match between the user and potential matches. Also, a user may reveal his/her profile information to a prospect selectively, in stages, as the user gets to know the prospect better. In one implementation of the method, these stages consist of an intuitive set of multiple, secure interaction stages through which two users are guided as they are matched and subsequently (should they want to) get to know each other. The stages include: (a) Stage R: Review your recommended match; (b) Stage 1: Break the ice; (c) Stage 2: Learn more; (d) Stage 3: Get talking; and (e) Stage 4: Plan meeting, as illustrated in FIG. 14. Two matched users begin at Stage R, when they are first matched with each other, and, depending on mutual interest, they may choose to move sequentially through the next stages of interactions and continue to explore compatibility with each other.

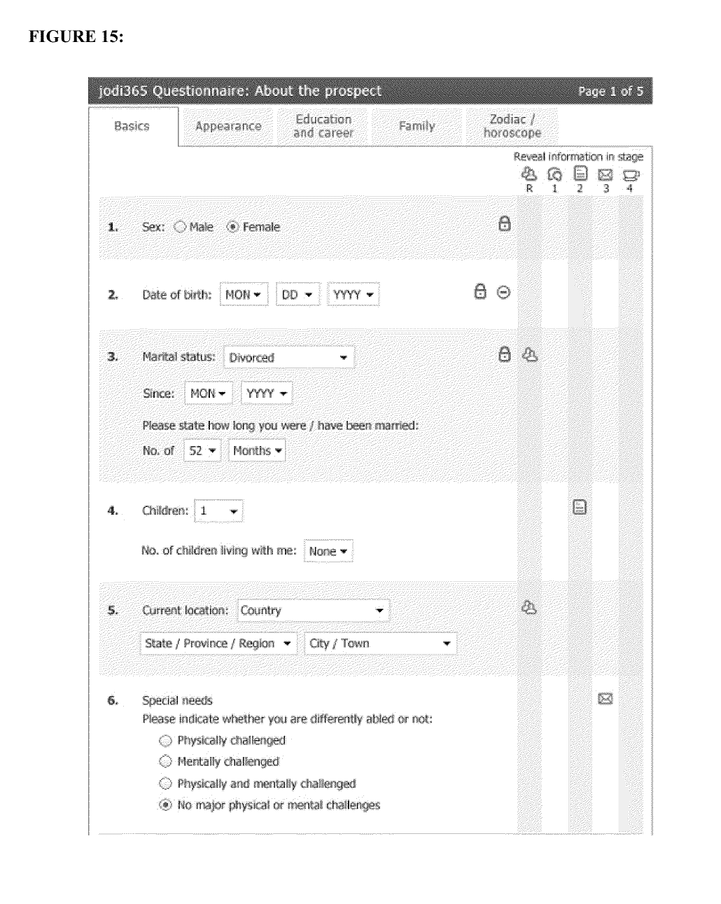

The user has the ability to choose specifically when (that is, at what stage of interactions) they reveal certain profile particulars to prospects. The profile privacy control mechanism may be automated, adjusted, or re-adjusted by a user through the activation of appropriate profile information display settings, to open up specific fields or sections of the user's profile to a prospect, depending on the stage or level of interactions reached by the user in his or her interactions with the prospect. In one implementation of the method, the user associates stage-specific privacy settings to their profile particulars as illustrated in FIG. 15.

The profile privacy control mechanism allows for a user to request, of a prospect, the revealing of specific fields or sections of the prospect's profile and for the prospect to deliberately reveal (should they choose to) specific fields or sections of their profile to the user.

A user may express to a prospect a desire to bypass the structured interaction stages and initiate “Quick Contact.” In one implementation of the method, such a Quick Contact message or request may take the form of requesting the prospect's e-mail address, phone number, instant-messaging handle, or even a meeting with the prospect.

A user's “responsiveness” rating is calculated as a function of how responsive the user is to requests (including invitations to communicate) and gestures (including compliments) from prospects. Variables that go into the calculation of the responsiveness rating include the fraction and volume of requests and gestures responded to and the time taken to respond to them.

In one implementation of the invention, when a user is contacted by a prospect, the user is presented with response options that include, “I need more time to respond,” besides typical response options such as “I am interested and accept your invitation to communicate” and “I am not interested and decline your invitation to communicate.” When a user is contacted by a prospect and buys time with an “I need more time to respond” reply, prospects who receive such a reply may contact the user again after a certain period of time, at which point if the user were not to respond to the prospect in a timely manner, it would count adversely against the user's responsiveness rating. When a user has more than a set number of “I need more time to respond” replies outstanding, the user's ability to contact other prospects may be placed on hold until the user attends to the outstanding and overdue messages.

The system-implemented method includes a matchmaking web site or system, in which the users enter information about them and their partner preferences and also involve other individuals—such as a relative, friend, or acquaintance—in his or her search for a partner. Additionally, the system-implemented method includes a separate but integrated networking web site or system at which the users may create and expand their social graphs by connecting online with the people in their lives. The integration between the matchmaking site and the networking site enables users of the matchmaking site (including individual users and their families) to do due diligence on prospective matches with the help of the networking site. In one implementation of the system, the due diligence may take the form of assessing someone's personal and professional background and network of relationships. Using the integrated networking site, the two users of the matchmaking site may discover connections such as peers, friends, or acquaintances they may have in common.

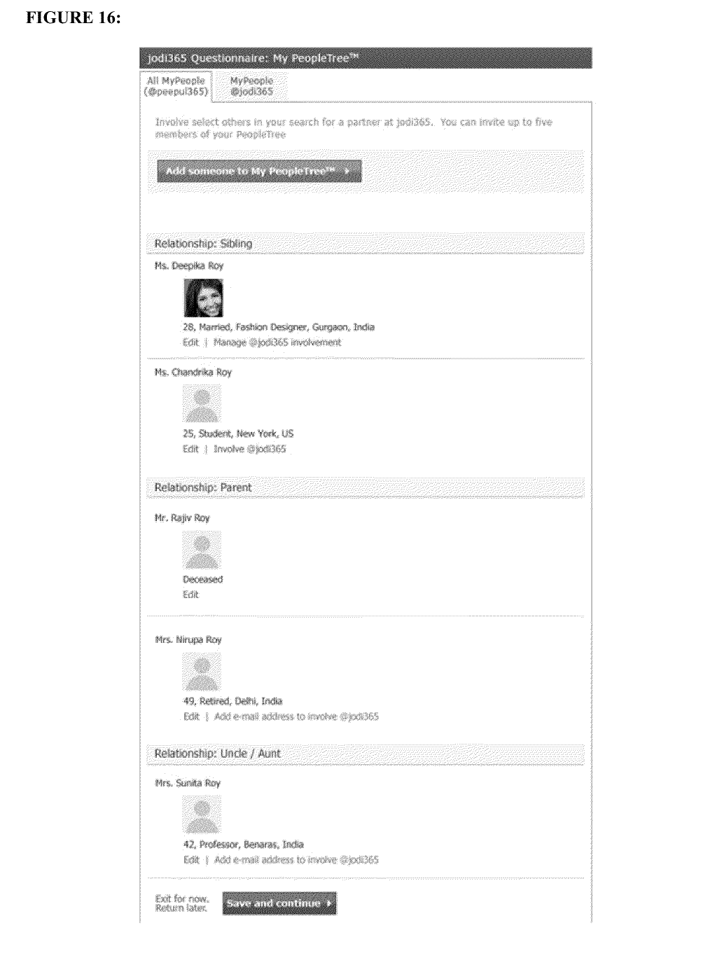

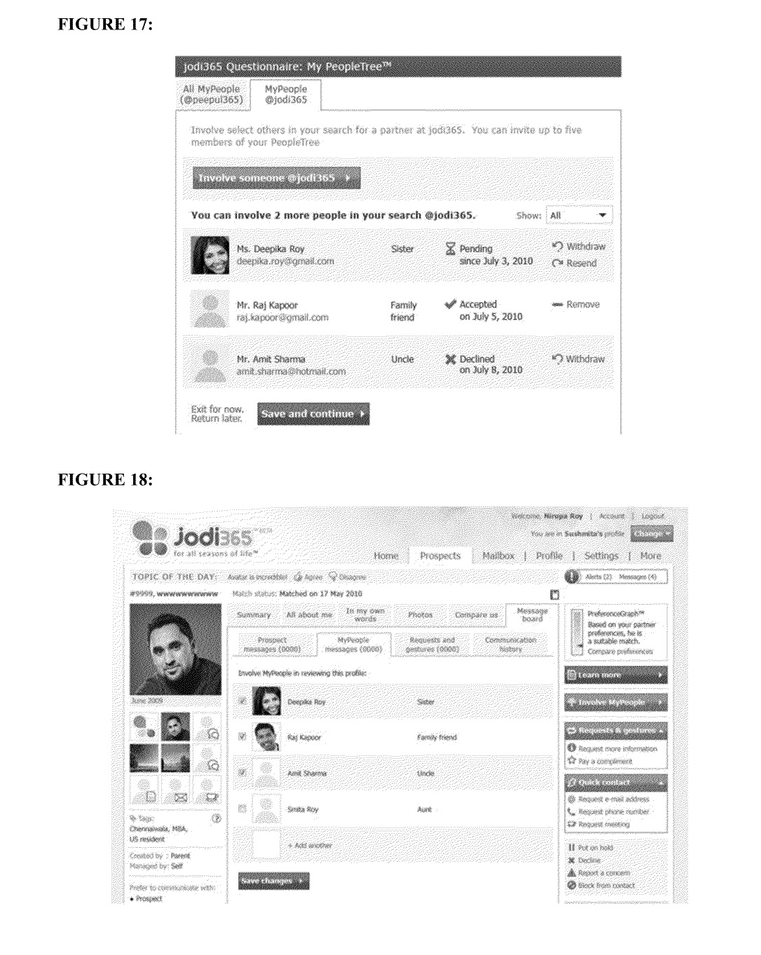

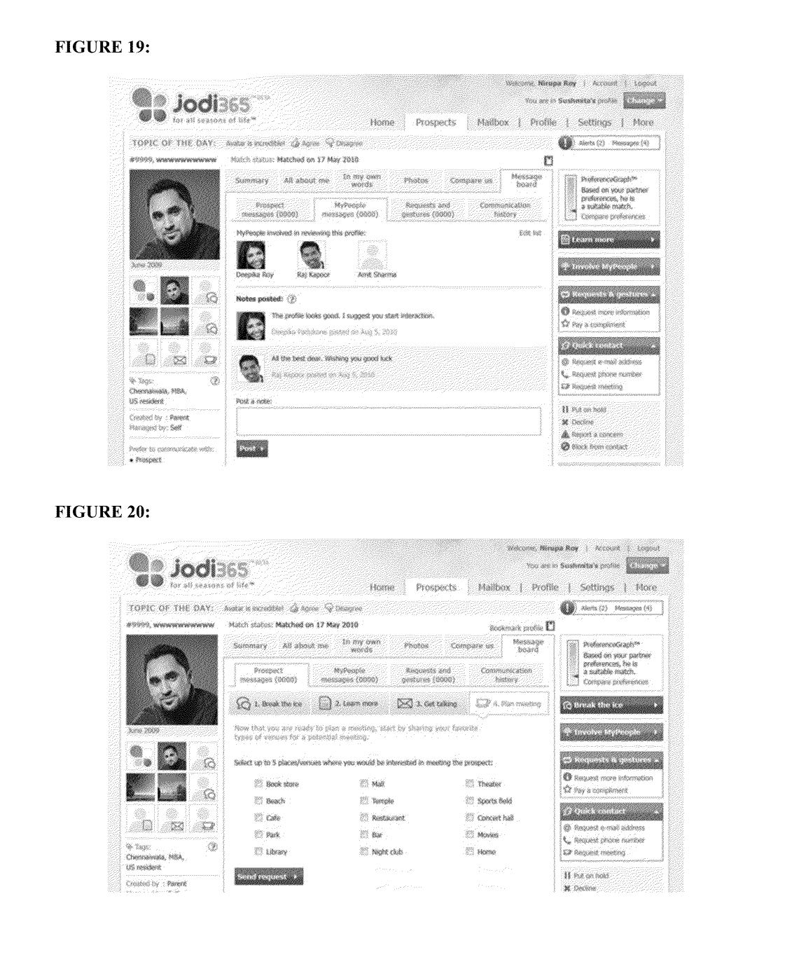

The foregoing objects relating to the involving of select others in a user's search process for a partner; the integration of the matchmaking and networking sites or systems; and the verification of a prospect's background are explained hereunder with reference to an implementation of the method. At the networking site, users establish and expand their family and personal networks by creating a “PeopleTree” and connecting with trusted relatives, neighbors, family friends, teachers, doctors, and other people in their lives. The PeopleTree consists of a list and mini-profiles of the connected people and also, potentially, links to fuller profiles of the people, if they are also on the networking site and consent to such linking Once the user registers an account at the matchmaking site, he or she automatically establishes an account at the networking site. A user may populate his or her PeopleTree either directly at the networking site or within the matchmaking site, while creating a profile, as shown in FIG. 16. Then a user may indicate who else from within their PeopleTree is involved in their search for a partner. This may be done at the matchmaking site profile creation stage as shown in FIG. 17, or on a case-by-case basis, from within a potential match's profile page, as shown in FIG. 18. Each individual so designated as being part of the so-called “MyPeople” team would then receive an e-mail inviting him/her either to create a profile on the networking site (if they do not have one there already); to accept the user's invitation to be part of his/her MyPeople team at the matchmaking site; and to port select (summary) information from his/her networking site profile to the user's profile page at the matchmaking site. That is, each of the MyPeople thumbnail sketches at a user's matchmaking site profile (see, e.g., the left column in FIG. 7) may be linked to the respective MyPeople members' networking site profile summaries. This select set of MyPeople (up to, say, five) would then get privileges to review and rate the user's potential matches, through their own networking site accounts which interface with the user's account and at a potential match's profile on the matchmaking site. Such reviews, ratings, and messages may remain private to the MyPeople team. The MyPeople messages functionality is illustrated in FIG. 19.

The system includes multiple individuals and “group” logins associated with a user profile on the matchmaking site, with appropriate read/review/rate/communicate privileges for the MyPeople members set by the matchmaking site user's designated profile manager.

A user may set up a “prospect ratings” sheet corresponding to his or her partner preferences and provide his or her MyPeople team members with the option of submitting their opinions on or ratings of the prospects. A matchmaking site user's MyPeople team may have privileges that include forwarding a profile to someone; adding searched profiles to the user's shortlist, for his/her consideration; rating shortlisted profiles or prospects; and even initiating communications or interactions with a prospect at the site, on behalf of the user. MyPeople members may also insert testimonials or provide references to the user. The user and his/her “people” would have the option of later changing the stage, nature, and extent of such MyPeople involvement in the search process for a partner.

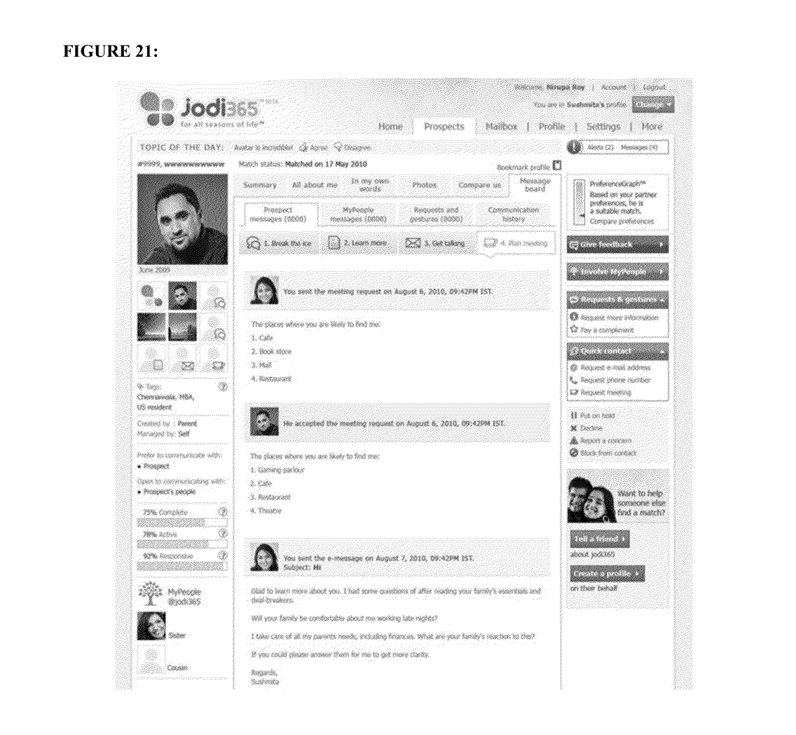

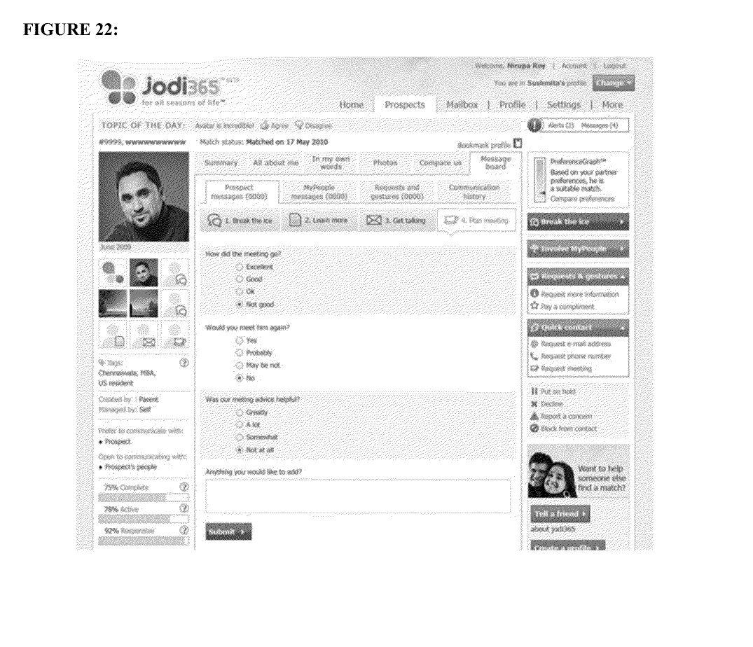

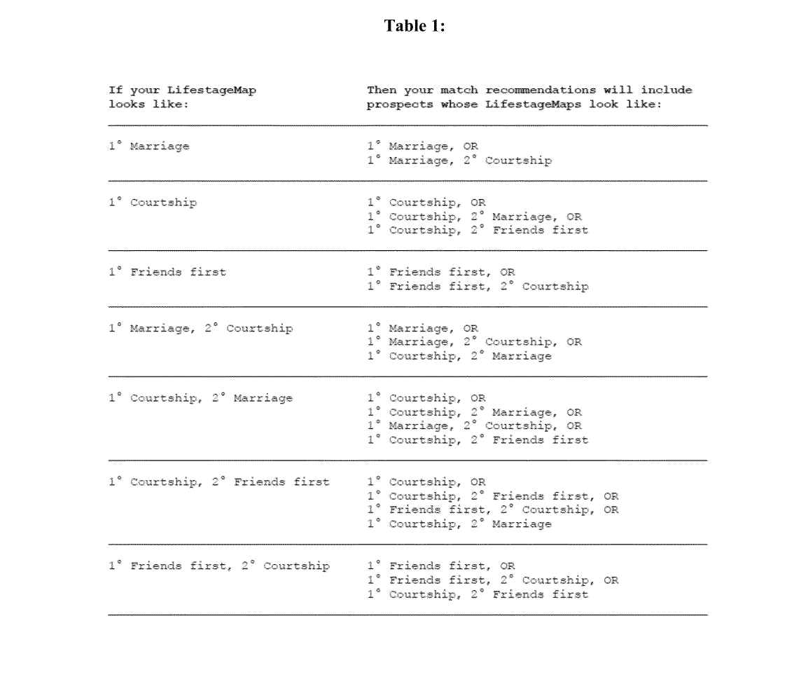

The method facilitates meetings between two users (with or without either's family members being involved) as illustrated in FIG. 20, FIG. 21, and FIG. 22, and includes exchanging of meeting type/venue preferences; meeting protocol or customs; and the collecting of post-meeting feedback on the other user.

The method also facilitates online interactions between users in a manner that mimics users' entering a room and knowing, readily, with whom they have things in common. In an implementation of the method, when a user enters such a chat or discussion room online, the system would flag those other users who share, say, the user's socio-cultural or socio-economic background, values, ideals, lifestyle choices, interests, aspirations, personality traits, or even prevailing mood, or those users who may be potential matches, and, if so desired, signal to the concerned users that another user of interest is in the “vicinity,” so as to facilitate the striking up of conversation.

1. A system-implemented method of determining compatibility and facilitating matching between users of the method, comprising the following:
a matchmaking web site;
registration of users;
creation of a user profile by registered users;
enabling users to provide their partner preferences;
collating and processing of information, within one or more databases, relating to user profiles and users' partner preferences;
assigning of weights to users' partner preferences;
matching of users with other, potentially compatible users or prospects;
determining degree of match between the matched users;
notifying users of other users with whom they may be compatible;
displaying users' profiles to their potential matches;
facilitating multiple means and multiple stages of communication and interaction between users;
assigning users a responsiveness rating that is calculated based on how responsive they are to other users on the site;
a user profile privacy control mechanism that enables users to control which prospects get to view their profile particulars and at what stage in a user's interactions with a prospect;
charging users a fee in real or virtual currency to permit them to communicate or interact with other users;
allowing users to earn redeemable credits, virtual currencies, or points for activities or specific actions undertaken on the site;
enabling a user to involve other individuals in the search for a partner, with appropriate user privileges set by the user's designated profile manager;
enabling multiple individuals and “group” logins to be associated with a user profile;
archiving the progression of users' interactions with and potential relationship stories involving other users; and
a social networking web site.

2. A system-implemented method as claimed in claim 1, wherein the user registration may be restricted and is either by invitation only or enabled only for credentialed users.

3. A system-implemented method as claimed in claim 2, wherein the verification of a user's credentials may be achieved by means of a gateway providing access to verified members.

4. A system-implemented method as claimed in claim 1, wherein the categorization and matching of users is based on criteria that include the users' respective lifestages and indicated time frames for marriage, wherein the time frames may be similar or overlapping.

5. A system-implemented method as claimed in claim 4, wherein the life stages and time frames for marriage may be user-customizable.

6. A system-implemented method as claimed in claim 1, wherein the registered users may customize the profile particulars they wish to see displayed as part of a prospect's profile summary.

7. A system-implemented method as claimed in claim 1, wherein the system enables the collection and display of information relating to the variation of a user's profile characteristics over time.

8. A system-implemented method as claimed in claim 1, wherein the system enables a user's partner preferences to be updated automatically following an updating of information about the user.

9. A system-implemented method as claimed in claim 1, wherein the system enables a user to indicate their partner preferences in absolute terms and/or in relative terms.

10. A system-implemented method as claimed in claim 1, wherein the method incorporates Boolean logic to allow people to make trade-offs in their partner preferences.

11. A system-implemented method as claimed in claim 1, wherein the user's partner preferences, are collected and processed in a manner that captures how important a potential criterion is relative to another and also, within a potential criterion, how preferable some possible preferences, values, or ranges of values are relative to other possible preferences, values, or ranges of values.

12. A system-implemented method as claimed in claim 1, wherein the weights may be assigned default values by the system and/or may be user customizable.

13. A system-implemented method as claimed in claim 12, wherein the weights may derive either wholly from user-specified weights or partly from user-specified weights; empirical data; hypotheses on the relative importance of potential criteria and the variation of people's partner preferences within each possible criterion; input from people known to the user; user behavior, including a user's browsing history on the site; and/or user interactions history, including feedback and information on why users approved, disapproved, accepted, rejected, were interested in or uninterested in previous prospects.

14. A system-implemented method as claimed in claim 1, wherein the profile privacy control mechanism may be automated, adjusted, or re-adjusted by a user.

15. A system-implemented method as claimed in claim 1, wherein the profile privacy control mechanism allows for a user to request, of a prospect, the revealing of profile particulars.

16. A system-implemented method as claimed in claim 1, wherein how much a user is charged to communicate or interact with other users is a function of the degree of match between the two users.

17. A system-implemented method as claimed in claim 1, wherein a user may specify additional monies, in any appropriate unit of real or virtual currency, that a prospect would have to pay to communicate or interact with the user.

18. A system-implemented method as claimed in claim 1, wherein the profile display particulars includes the charges payable in real or virtual currency to communicate or interact with the prospect.

19. A system-implemented method as claimed in claim 1, wherein if a user's responsiveness rating falls below a threshold, then the user's ability to communicate or interact with prospects may be placed on hold.

20. A system-implemented method as claimed in claim 1, wherein the user and any of the individuals involved in the user's search may have the option of changing the stage, nature, and extent of such involvement.

21. A system-implemented method as claimed in claim 1, wherein a matchmaking site user's group members may have privileges that include offering testimonials for inclusion in a user's profile; serving as references to a user; forwarding a profile to another user or potential user; adding searched profiles to a user's shortlist, for his/her consideration; reading, reviewing and rating user profiles; and interacting with a prospect at the site.

22. A system-implemented method as claimed in claim 21, wherein a user group's reviews, ratings, and messages pertaining to a prospect's profile may remain private to the group concerned and specific to that prospect's profile.

23. A system-implemented method as claimed in claim 1, wherein the method facilitates meetings between two users, with or without either user's group members being involved, and includes exchanging of relevant information.

24. A system-implemented method as claimed in claim 1, wherein the method also facilitates the coming together of potentially compatible users for online interactions that include instant messaging and near-real-time communications or interactions.

25. A system-implemented method as claimed in claim 1, wherein users are provided with the means to collate prospects' contact information and pertinent particulars into a repository or database.

26. A system-implemented method as claimed in claim 1, wherein the system may extract and present to a pair of users their profile particulars, interaction history, activity stream, and/or any other relevant or interesting information.

27. A system-implemented method as claimed in claim 1, wherein in the matchmaking web site the users enter profile information and indicate partner preferences, and in the networking web site the users create and expand their social graphs by connecting online with other people.

28. A system-implemented method as claimed in claim 27, wherein a user may populate his or her network either directly at the networking site or from within the matchmaking site.

29. A system-implemented method as claimed in claim 27, wherein a user may port select information from his or her networking site profile to his or her profile at the matchmaking site.

30. A system-implemented method as claimed in claim 27, wherein a group member's profile at a user's matchmaking site profile may be linked to the group member's networking site profile.

31. A system-implemented method as claimed in claim 1, wherein users of the matchmaking site may discover, using the networking site, connections they may have in common; verify prospects' identities and backgrounds; and/or better gauge compatibility using additional potential information gathered from the networking site.
